(19) United States
(12) Patent Application Publication
(10) Pub. No.: US 2022/0126621 A1
(43) Pub. Date: Apr. 28, 2022

(54) SHEET ASSEMBLY FOR FORMING ONE OR MORE CARDS

(71) Applicant: Illinois Tool Works Inc., Glenview, IL (US)

(72) Inventors: Suwit John Sangkaratana, Crown Point, IN (US); Michael B. Colella, Southington, CT (US); Daniel Szumski, Saint John, IN (US)

(73) Assignee: Illinois Tool Works Inc., Glenview, IL (US)

(21) Appl. No.: 17/507,433

(22) Filed: Oct. 21, 2021

Related U.S. Application Data
(60) Provisional application No. 63/105,768, filed on Oct. 26, 2020.

(51) Int. Cl. B42D 25/36; B42D 25/47; B32B 7/12; B42D 25/475; B42D 25/42; B42D 25/305; B32B 27/08; B32B 27/20

(52) U.S. Cl. CPC B42D 25/36; B42D 25/47; B32B 7/12; B42D 25/475; B42D 25/42; B42D 25/305; B32B 2425/00; B32B 27/20; B32B 2264/10; B32B 2264/303; B32B 2307/202; B32B 2307/206; B32B 2307/4023; B32B 27/08

(57) ABSTRACT

A sheet assembly can be cut into one or more cards. The sheet assembly includes an upper sheet configured to receive a first printing of first indicia for the one or more cards, a polymer core coupled with the upper sheet, and a lower sheet configured to receive a second printing of second indicia for the one or more cards. The lower sheet is coupled with the polymer core with the polymer core disposed between the upper sheet and the lower sheet. The upper sheet, polymer core, and/or the lower sheet is or are formed from a polymer binder with inorganic particles dispersed in the polymer binder. The inorganic particles can have a first density of the inorganic particles that is less than four times a second density of the polymer binder and/or a mass-median-diameter (D₅₀) of the inorganic particles can be larger than ten microns in size.

### CROSS-REFERENCE TO RELATED APPLICATIONS

This application claims priority to U.S. Provisional Application No. 63/105,768 (filed 26 Oct. 2020), the entire disclosure of which is incorporated herein by reference.

### BACKGROUND

### Technical Field

The subject matter described herein relates to multi-layer sheet assemblies that can be cut into smaller cards, such as identification cards, financial transaction cards (e.g., credit cards, debit cards, gift cards, or the like), or other types of cards.

### Discussion of Art

Cards are used for a variety of purposes, such as identification or security, financial transactions, etc. Some higher-end financial transaction cards are made from or include metals to provide a heavier card, which can be desirable by customers. But, inclusion of these types of materials can make it harder or more costly to recycle the cards.

### BRIEF DESCRIPTION

In one embodiment, a sheet assembly is provided that can be cut into one or more cards. The sheet assembly includes an upper sheet configured to receive a first printing of first indicia for the one or more cards, a polymer core coupled with the upper sheet, and a lower sheet configured to receive a second printing of second indicia for the one or more cards. The lower sheet is coupled with the polymer core with the polymer core disposed between the upper sheet and the lower sheet. The upper sheet, the polymer core, and/or the lower sheet is or are formed from a polymer binder with inorganic particles dispersed in the polymer binder. The inorganic particles can have a first density of the inorganic particles that is less than four times a second density of the polymer binder and/or a mass-median-diameter (D₅₀) of the inorganic particles can be larger than ten microns in size.

In one embodiment, a method for producing the sheet assembly is provided. The method includes forming a polymer core and coupling an upper sheet to the polymer core. The upper sheet is configured to receive a first printing of first indicia for one or more cards. The method also includes coupling a lower sheet to the polymer core to form a sheet of the upper sheet, the polymer core, and the lower sheet. The lower sheet is coupled with the polymer core with the polymer core disposed between the upper sheet and the lower sheet. The lower sheet is configured to receive a second printing of second indicia for the one or more cards. The upper sheet, the polymer core, and the lower sheet are configured to be cut into one or more cards. The upper sheet, polymer core, and/or lower sheet is or are formed from a polymer binder with inorganic particles dispersed in the polymer binder. A first density of the inorganic particles is less than four times a second density of the polymer binder and/or a mass-median-diameter (D₅₀) of the inorganic particles is larger than ten microns in size.

In one embodiment, a sheet assembly is provided that can be cut into one or more cards. The sheet assembly includes an upper sheet configured to receive a first printing of first indicia for the one or more cards, a polymer core coupled with the upper sheet, and a lower sheet configured to receive a second printing of second indicia for the one or more cards. The lower sheet is coupled with the polymer core with the polymer core disposed between the upper sheet and the lower sheet. The upper sheet, the polymer core, and/or the lower sheet is or are formed from a polymer binder with inorganic particles dispersed in the polymer binder with a first density of the inorganic particles being at least 5.5 grams per cubic centimeter but less than four times a second density of the polymer binder that is at least 1.4 grams per cubic centimeter.

### BRIEF DESCRIPTION OF THE DRAWINGS

The inventive subject matter may be understood from reading the following description of non-limiting embodiments, with reference to the attached drawings, wherein below:

FIG. 1 illustrates a perspective view of one embodiment of a multi-layer sheet assembly;

FIG. 2 illustrates a cross-sectional view of the sheet assembly shown in FIG. 1 along line 2-2 in FIG. 1;

FIG. 3 illustrates a cross-sectional view of one of the cards that is cut from the sheet assembly shown in FIG. 1 along line 2-2 in FIG. 1;

FIG. 4 illustrates an exploded view of a card according to an alternative embodiment; and

FIG. 5 illustrates a flowchart of one example of a method for forming a sheet assembly that can be cut into smaller cards.

### DETAILED DESCRIPTION

The inventive subject matter described herein provides multi-layer sheet assemblies from which several cards can be cut. The cards can be shaped for use as identification cards, financial transaction cards, etc. In one embodiment, the sheet assemblies can be formed from materials that provide metal-like or heavy cards (e.g., cards that feel heavier as though the cards include metal), without the sheets or cards actually including metal or a metal layer. Instead, the sheet assemblies and cards can include a highly filled plastic compound having filler material with a large density (e.g., at least 6.1 grams per cubic centimeter in one embodiment) and a dispersing or binder material with a smaller density (e.g., at least 1.55 grams per cubic centimeter in one embodiment). The filler material can have a density that is less than four times the density of the binder material. This can provide for cards that are at least twice as heavy as the known cards formed from polyvinyl chloride (PVC) (e.g., at least 11 grams versus 5.5 grams). The cards may include other functionalities or components, such as reflective, diffractive, or opaque layers, radio frequency identification (RFID) antennas or circuits, etc. The cards may not be electrically conductive and therefore may not conduct electrostatic discharge (ESD) from one edge of a cards to any of the three other edges of the card.

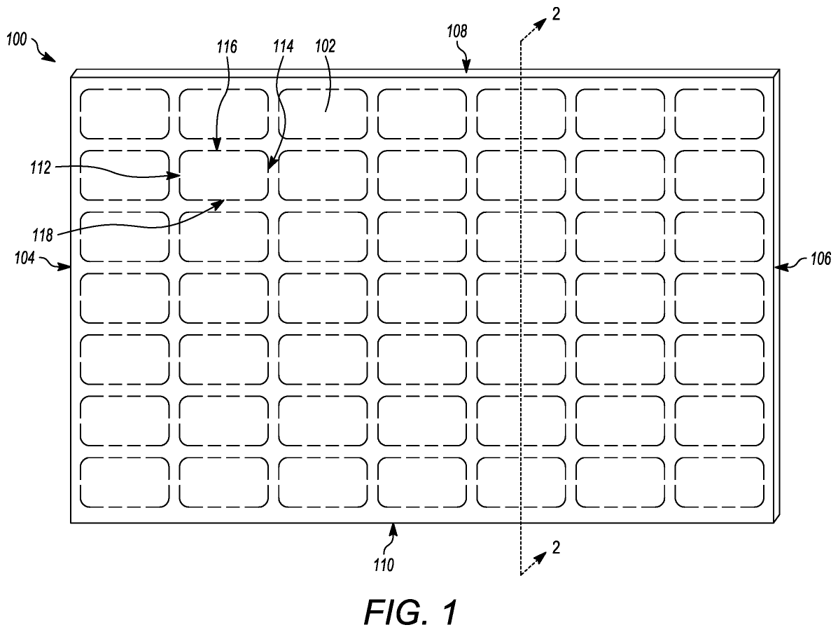

FIG. 1 illustrates a perspective view of one embodiment of a multi-layer sheet assembly 100. The sheet assembly 100 can be large enough to cut several cards 102 from the sheet assembly. These cards 102 may be identification cards (e.g., drivers' licenses, work identification cards, etc.), financial transaction cards (e.g., credit cards, debit cards, gift cards, etc.), or the like. In one embodiment, each of the cards 102 has a shape and size defined by the ISO/IEC 7810 ID-1 standard. Alternatively, the cards 102 may have a different shape and/or size. The sheet assembly 100 may be large enough to cut several (e.g., sixty-three or another number) of the cards 102 from the sheet assembly 100. For example, the sheet assembly 100 may have a surface area on each side of the sheet assembly 100 that is at least 2,911 square centimeters.

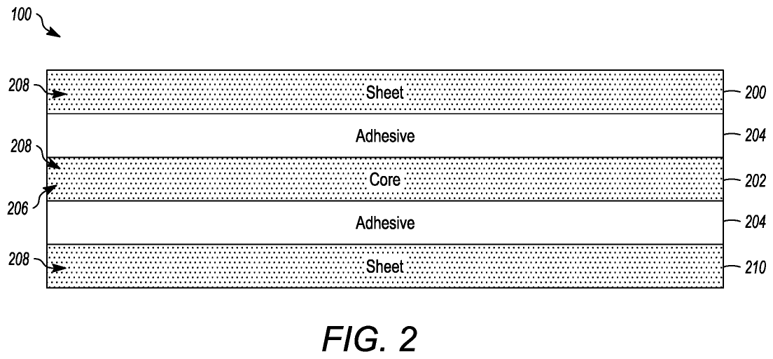

FIG. 2 illustrates a cross-sectional view of the sheet assembly 100 shown in FIG. 1 along line 2-2 in FIG. 1. The sheet assembly 100 includes an upper polymer sheet 200 that can receive a printing of indicia for the cards 102 (shown in FIG. 1). For example, the sheet 200 can be a layer formed from a binder of polyethylene terephthalate (PET) or another polymer. Optionally, the sheet 200 can be formed from a binder of polyvinyl chloride (PVC), polyethylene terephthalate (PET), polycarbonate (PC), copolymerized PET (PETG), a bio-based polymer, an oceans plastic, an ocean-bound plastic, a recycled plastic, or the like. The sheet 200 can include inorganic particles 208 dispersed in and/or throughout the binder of the sheet 200. The components shown in FIG. 2 are not drawn to scale, as the particles 208 may appear larger relative to the thicknesses of the various sheets, layers, and core in FIG. 2 than the particles 208 actually are. The binder of the sheet 200 can be formed from a polymer material that is capable of being printed upon by inks to form indicia on a visible surface (e.g., top or front surface) of the sheet 200 and the card(s) 102. The indicia can include identifying information (e.g., a person's name, a company name, an account number, a photograph, an image, etc.) or other information. Optionally, the sheet 200 does not include the particles 208.

The sheet 200 is coupled with a polymer core 202 by an adhesive 204. The core 202 is a layer forming the middle or bulk of the cards 102 that are eventually cut from the sheet assembly 100. The adhesive 204 can be applied onto the core 202 with the sheet 200 placed onto the adhesive 204. The core 202 is formed from a polymer binder 206 having the inorganic particles 208 dispersed in and/or throughout the binder 206.

The sheet assembly 100 also includes a lower polymer sheet 210 coupled with the core 202 by additional adhesive 204. The sheet 210 also can receive a printing of indicia for the cards 102. The sheet 210 also can have a binder formed from PET, PVC, PET, PC, PETG, a bio-based polymer, an oceans plastic, an ocean-bound plastic, a recycled plastic, or the like. The sheet 210 can include the inorganic particles 208 dispersed in and/or throughout the binder of the sheet 210. The binder of the sheet 210 can be formed from a polymer material that is capable of being printed upon by inks to form indicia on a visible surface (e.g., bottom or back surface) of the sheet 200 and/or the card(s) 102. Optionally, the sheet 210 does not include the particles 208. In one embodiment, all three of the sheets 200, 210 and the core 202 include the particles 208. In another embodiment, the core 202 includes the particles 208 but the sheets 200, 210 do not include the particles 208. In another embodiment, the sheets 200, 210 include the particles 208 but the core 202 does not include the particles 208. In another embodiment, only one of the sheet 200 or the sheet 210 includes the particles 208, but the other of the sheet 210 or the sheet 200 and the core 202 does not include the particles 208.

As described below, one or more additional layers, sheets, or components may be included in the sheet assembly 100 and/or placed on the sheets 200 and/or 210 prior to or after the cards 102 are cut from the sheet assembly 100 to complete manufacture of the cards 102. The core 202 of the sheet assembly 100 and the cards 102 (with or without the sheets 200, 210) provides for increased weight of the cards 102 (which can be desirable for higher end or luxury transactional cards) without having to include metal layers within the sheet assembly 100 or the cards 102. This can prevent the sheet assembly 100 and each of the cards 102 from forming, having, or including a conductive layer that conducts ESD or other electric current through the sheet assembly 100 or the card(s) 102.

For example (and as shown in FIG. 1), the sheet assembly 100 (and the sheets 200, 210 and the core 202) may continuously extend from a first edge 104 to an opposite second edge 106, and may continuously extend from a third edge 108 (that intersects both the first edge 104 and the second edge 106) to an opposite fourth edge 110 (that intersects both the first edge 104 and the second edge 106). Each of the cards 102 similarly may continuously extend from a first edge 112 to an opposite second edge 114, and may continuously extend from a third edge 116 (that intersects both the first edge 112 and the second edge 114) to an opposite fourth edge 118 (that intersects both the first edge 112 and the second edge 114). But, the absence of a conductive layer, sheet, core, or body in the sheet assembly 100 and in each of the cards 102 can prevent the sheet assembly 100 from conducting ESD or other electric current from one sheet edge 104, 106, 108, 110 to any other sheet edge 104, 106, 108, 110 and can prevent each of the cards 102 from conducting ESD or other electric current from one card edge 112, 114, 116, 118 to any other card edge 112, 114, 116, 118.

The sheet 200, core 202, and/or sheet 210 can provide added weight to the cards 102 relative to using other known polymer core cards by using a combination of the binder 206 and the particles 208 that have increased densities (relative to the polymers used in other known cards). For example, the density of the particles 208 may be up to, but less than, four times the density of the binder 206. In one embodiment, the density of the particles 208 is at least 5.5 grams per cubic centimeter and the density of the binder 206 may be at least 1.4 grams per cubic centimeter. Alternatively, the density of the particles 208 may be at least 6.1 grams per cubic centimeter and the density of the binder 206 may be at least 1.55 grams per cubic centimeter. Examples of materials that may be used for the binder 206 include polyvinyl chloride, chlorinated polyvinyl chloride, polyvinylidene chloride, polyvinylidene fluoride, polytetrafluoroethylene, polyethylene terephthalate, polyethylene terephthalate glycol-modified, a bio-based polymer, a cellulosic polymer, a polyolefin, a polyactic acid-based polymer, an oceans plastic, an ocean-bound plastic, and/or a recycled plastic. The inorganic particles 208 include one or more of bismuth vanadate, one or more metal oxide pigments, or one or more conductive particles (e.g., copper particles, bronze particles, etc.). While the inorganic particles may include metal, metal oxides, or other conductive particles, the inorganic particles can be separated from each other by the binder 206 such that no conductive pathway exists through the sheet assembly 100 and/or cards 102 from one edge or any other edge via the inorganic particles 208.

The inorganic particles 208 can be relatively large. For example, a mass-median-diameter (D₅₀) of the inorganic particles 208 within each card 102 and/or throughout the sheet assembly 102 may be larger than ten microns in size. Alternatively, the mass-median-diameter (D₅₀) of the inorganic particles 208 within each card 102 and/or throughout the sheet assembly 102 may be larger than fifteen microns in size.

In one embodiment, one or more of the polymer sheets 200, 210 can include the inorganic particles 208. For example, the polymer sheet 200 and/or 210 can include inorganic particles 208 in addition to or instead of the core including the inorganic particles 208. This can further increase the weight of the card 102.

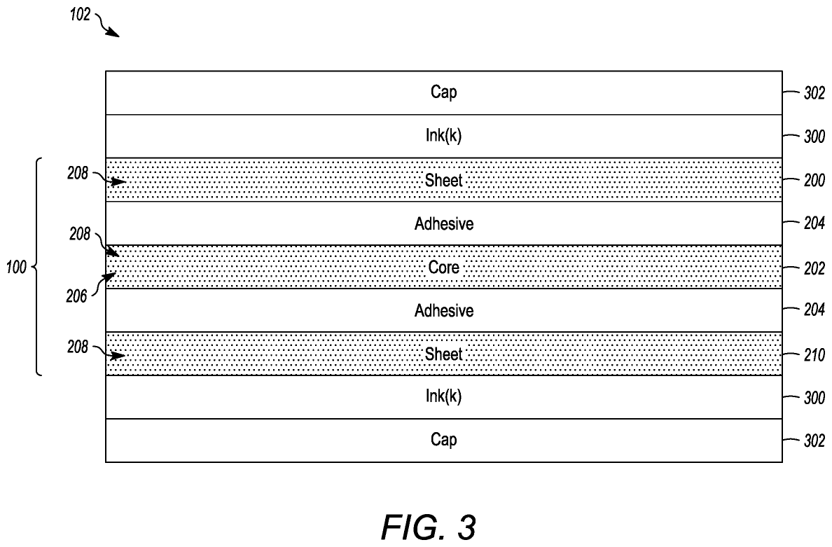

FIG. 3 illustrates a cross-sectional view of one of the cards 102 that is cut from the sheet assembly 100 shown in FIG. 1 along line 2-2 in FIG. 1. The layers forming the sheet assembly 100 are labeled with reference number 100 in FIG. 3. After cutting the card 102 from the sheet assembly 100, one or more inks 300 may be printed, transferred, or otherwise deposited onto the upper sheet 200 and/or the lower sheet 210. These inks 300 can form text, numbers, images, or the like, for use in identifying a holder of the card 102, identifying a financial institution, identifying an account, or the like. Optionally, the inks 300 can form graphics or the like. While the inks 300 are shown in FIG. 3 as a continuous layer extending over the sheet 200 and under the sheet 210, alternatively, the inks 300 may only cover part, but not all, of the sheet 200 and/or the sheet 210.

Cap layers 302 can be printed or deposited over the inks 300 to protect the inks from removal from the upper and/or lower sheets 200, 210. For example, a clear polymer layer or sheet can be formed on the upper sheet 200 and/or the lower sheet 210. This clear polymer layer or sheet can be formed from PVC or another polymer with a clear adhesive between the clear polymer layer and each of the sheets 200, 210.

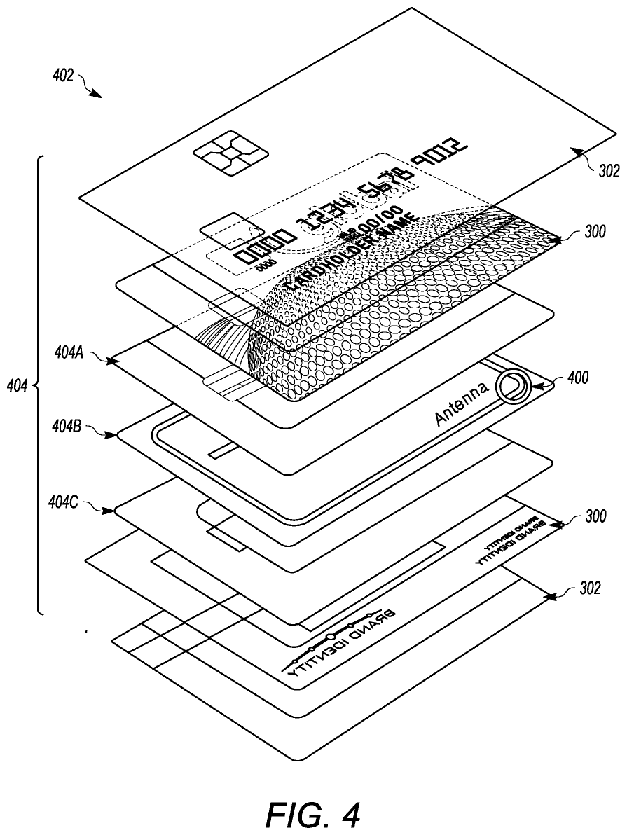

FIG. 4 illustrates an exploded view of a card 402 according to an alternative embodiment. The card 402 can represent one of the cards 102 that is cut from the sheet assembly 100. The card 402 includes the upper cap layer 302, the upper sheet 200, the inks 300 on the upper sheet 200, the lower sheet 210, the inks 300 on the lower sheet 210, and the lower cap layer 302. The card 402 also includes a split core 404, which represent be the core layer 202 divided into multiple thinner layers or sheets 404A-C. The split core layer 404A can be referred to as the front split core layer, the split core layer 404B can be referred to as the middle split core layer, and the split core layer 404C can be referred to as the back split core layer. The card 402 also can include the adhesive between the split core 404 and the sheets 200, 210, and between the inks 300 and the caps 302 (although the adhesive is not shown in FIG. 4).

The split core 404 can provide added weight to the card 402 by including the combination of the binder 206 and the particles 208 described above. Optionally, the split core 404 can include one or more inlays 400, such as an electronic circuit or antenna, in one or more of the split core layers 404A-C, between two of the split core layers 404A-C, and/or between the split core layer 404 and the inks 300. In the illustrated embodiment, the inlay 400 is disposed within the middle split core layer 404B. The inlay 400 can represent a radio frequency identification (RFID) antenna that can be used to receive and/or communicate electromagnetic signals via electromagnetic waves responsive to being interrogated by an RFID reader. For example, the circuit inlay 400 can be used for contactless or wireless transactions involving the card 402.

The split core layers 404A-C also can include one or more optical features of the card 402. For example, one or more metal sheets bodies, or the like, can be included in and/or added to the front split core layer 404A, the middle split core layer 404B, and/or the back split core layer 404C to form a reflective feature, a diffractive feature, and/or a holographic feature of the card 402.

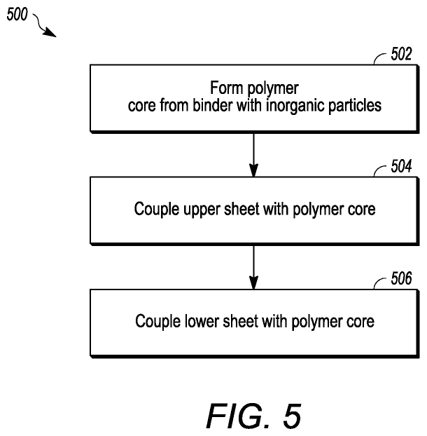

FIG. 5 illustrates a flowchart of one example of a method 500 for forming a sheet assembly that can be cut into smaller cards. The method 500 can represent the operations performed to create the sheet assembly 100 that is cut into the cards 102 and/or 402. At 502, a polymer core is formed from a polymer binder with inorganic particles dispersed in the polymer binder. As described above, a first density of the inorganic particles can be less than four times a second density of the polymer binder in the core. Optionally, a mass-median-diameter (D₅₀) of the inorganic particles in the core can be larger than ten microns in size. At 504, an upper sheet to the polymer core can be coupled with the core. The upper sheet can receive a first printing of first indicia for one or more cards, as described above. For example, the inks 300 may be printed on the upper sheet by the card manufacturer or producer.

At 506, a lower sheet is coupled to the polymer core to form a sheet assembly of the upper sheet, the polymer core, and the lower sheet. The lower sheet can be coupled with the polymer core with the polymer core disposed between the upper sheet and the lower sheet. Like the upper sheet, the lower sheet can receive a second printing of second indicia for the one or more cards.

In one embodiment, a sheet assembly is provided that can be cut into one or more cards. The sheet assembly includes an upper sheet configured to receive a first printing of first indicia for the one or more cards, a polymer core coupled with the upper sheet, and a lower sheet configured to receive a second printing of second indicia for the one or more cards. The lower sheet is coupled with the polymer core with the polymer core disposed between the upper sheet and the lower sheet. The polymer core is formed from a polymer binder with inorganic particles dispersed in the polymer binder. The inorganic particles can have a first density of the inorganic particles that is less than four times a second density of the polymer binder and/or a mass-median-diameter (D₅₀) of the inorganic particles can be larger than ten microns in size.

Optionally, the polymer core is formed from the polymer binder with the inorganic particles dispersed in the polymer binder with the first density of the inorganic particles being less than four times the second density of the polymer binder.

Optionally, the mass-median-diameter (D₅₀) of the inorganic particles is larger than ten microns in size.

Optionally, both (a) the polymer core is formed from the polymer binder with the inorganic particles dispersed in the polymer binder with the first density of the inorganic particles being less than four times the second density of the polymer binder and (b) the mass-median-diameter (D₅₀) of the inorganic particles is larger than ten microns in size.

Optionally, the polymer core is coupled with the upper sheet and the lower sheet by adhesive.

Optionally, the first density of the inorganic particles is at least 5.5 grams per cubic centimeter.

Optionally, the first density of the inorganic particles is at least 6.1 grams per cubic centimeter.

Optionally, the second density of the polymer binder is at least 1.4 grams per cubic centimeter.

Optionally, the second density of the polymer binder is at least 1.55 grams per cubic centimeter.

Optionally, the inorganic particles include one or more of bismuth vanadate, one or more metal oxide pigments, or one or more conductive particles.

Optionally, the inorganic particles include the one or more conductive particles, which include one or more of copper particles or bronze particles.

Optionally, the polymer binder includes one or more of polyvinyl chloride, chlorinated polyvinyl chloride, polyvinylidene chloride, polyvinylidene fluoride, polytetrafluoroethylene, polyethylene terephthalate, polyethylene terephthalate glycol-modified, a bio-based polymer, a cellulosic polymer, a polyolefin, a polyactic acid-based polymer, an oceans plastic, an ocean-bound plastic, and/or a recycled plastic.

Optionally, the upper sheet, the polymer core, and the lower sheet continuously extend from a first edge of the sheet to an opposite second edge of the sheet, and the upper sheet, the polymer core, and the lower sheet continuously extend from a third edge of the sheet to an opposite fourth edge of the sheet with each of the third edge and the fourth edge continuously extending from the first edge to the second edge. The sheet may not conduct electric current from any of the first edge, the second edge, the third edge, and/or the fourth edge to any of the first edge, the second edge, the third edge, and/or the fourth edge.

Optionally, the polymer core includes a radio frequency identification antenna.

Optionally, the polymer core is formed from at least a front split core layer and a back split core layer with the front split core layer located between the back split core layer and the upper sheet and the back split core layer located between the front split core layer and the lower sheet.

Optionally, one or both of the front split core or the back split core includes one or more of a reflective feature, a diffractive feature, and/or a holographic feature.

Optionally, the polymer core is formed from a front split core layer, a back split core layer, and an inlay disposed between the front split core layer and the back split core layer. The inlay can include a radio frequency identification antenna.

Optionally, the sheet does not conduct electric current.

In one embodiment, a method for producing the sheet assembly is provided. The method includes forming a polymer core from a polymer binder with inorganic particles dispersed in the polymer binder, where one or more of a first density of the inorganic particles is less than four times a second density of the polymer binder and/or a mass-median-diameter (D₅₀) of the inorganic particles is larger than ten microns in size. The method also includes coupling an upper sheet to the polymer core. The upper sheet is configured to receive a first printing of first indicia for one or more cards. The method also includes coupling a lower sheet to the polymer core to form a sheet of the upper sheet, the polymer core, and the lower sheet. The lower sheet is coupled with the polymer core with the polymer core disposed between the upper sheet and the lower sheet. The lower sheet is configured to receive a second printing of second indicia for the one or more cards. The upper sheet, the polymer core, and the lower sheet are configured to be cut into one or more cards.

Optionally, the polymer core is formed from the polymer binder with the inorganic particles dispersed in the polymer binder with the first density of the inorganic particles being less than four times the second density of the polymer binder.

Optionally, the mass-median-diameter (D₅₀) of the inorganic particles is larger than ten microns in size.

Optionally, both (a) the polymer core is formed from the polymer binder with the inorganic particles dispersed in the polymer binder with the first density of the inorganic particles being less than four times the second density of the polymer binder and (b) the mass-median-diameter (D₅₀) of the inorganic particles is larger than ten microns in size.

Optionally, the polymer core is coupled with the upper sheet and the lower sheet by adhesive.

Optionally, the first density of the inorganic particles is at least 5.5 grams per cubic centimeter.

Optionally, the first density of the inorganic particles is at least 6.1 grams per cubic centimeter.

Optionally, the second density of the polymer binder is at least 1.4 grams per cubic centimeter.

Optionally, the second density of the polymer binder is at least 1.55 grams per cubic centimeter.

Optionally, the inorganic particles include one or more of bismuth vanadate, one or more metal oxide pigments, and/or one or more conductive particles.

Optionally, the inorganic particles include the one or more conductive particles, which include one or more of copper particles or bronze particles.

Optionally, the polymer binder includes one or more of polyvinyl chloride, chlorinated polyvinyl chloride, polyvinylidene chloride, polyvinylidene fluoride, polytetrafluoroethylene, polyethylene terephthalate, polyethylene terephthalate glycol-modified, a bio-based polymer, a cellulosic polymer, a polyolefin, a polyactic acid-based polymer, an oceans plastic, an ocean-bound plastic, and/or a recycled plastic.

Optionally, the upper sheet, the polymer core, and the lower sheet continuously extend from a first edge of the sheet to an opposite second edge of the sheet, and the upper sheet, the polymer core, and the lower sheet continuously extend from a third edge of the sheet to an opposite fourth edge of the sheet with each of the third edge and the fourth edge continuously extending from the first edge to the second edge. The sheet may not conduct electric current from any of the first edge, the second edge, the third edge, or the fourth edge to any of the first edge, the second edge, the third edge, or the fourth edge.

Optionally, the method also can include placing a radio frequency identification antenna in the polymer core.

Optionally, forming the polymer core includes forming at least a front split core layer and a back split core layer with the front split core layer located between the back split core layer and the upper sheet and the back split core layer located between the front split core layer and the lower sheet.

Optionally, one or both of the front split core or the back split core includes one or more of a reflective feature, a diffractive feature, or a holographic feature.

Optionally, forming the polymer core includes forming a front split core layer, a back split core layer, and an inlay disposed between the front split core layer and the back split core layer. The inlay can include a radio frequency identification antenna.

Optionally, the sheet does not conduct electric current.

In one embodiment, a sheet assembly is provided that can be cut into one or more cards. The sheet assembly includes an upper sheet configured to receive a first printing of first indicia for the one or more cards, a polymer core coupled with the upper sheet, and a lower sheet configured to receive a second printing of second indicia for the one or more cards. The lower sheet is coupled with the polymer core with the polymer core disposed between the upper sheet and the lower sheet. The polymer core is formed from a polymer binder with inorganic particles dispersed in the polymer binder with a first density of the inorganic particles being at least 5.5 grams per cubic centimeter but less than four times a second density of the polymer binder that is at least 1.4 grams per cubic centimeter.

Optionally, the inorganic particles are larger than ten microns in size.

Optionally, the inorganic particles include bismuth vanadate.

Optionally, the inorganic particles includes one or more metal oxide pigments.

Optionally, the polymer binder includes one or more of chlorinated polyvinyl chloride, polyvinylidene chloride, polyvinylidene fluoride, polytetrafluoroethylene, or a recycled plastic.

Optionally, the upper sheet, the polymer core, and the lower sheet continuously extend from a first edge of the sheet to an opposite second edge of the sheet, and the upper sheet, the polymer core, and the lower sheet continuously extend from a third edge of the sheet to an opposite fourth edge of the sheet with each of the third edge and the fourth edge continuously extending from the first edge to the second edge. The sheet may not conduct electric current from any of the first edge, the second edge, the third edge, or the fourth edge to any of the first edge, the second edge, the third edge, or the fourth edge.

Optionally, the polymer core includes a radio frequency identification antenna.

Optionally, the polymer core is formed from at least a front split core layer and a back split core layer with the front split core layer located between the back split core layer and the upper sheet and the back split core layer located between the front split core layer and the lower sheet.

Optionally, one or both of the front split core or the back split core includes one or more of a reflective feature, a diffractive feature, or a holographic feature.

Optionally, the polymer core is formed from a front split core layer, a back split core layer, and an inlay disposed between the front split core layer and the back split core layer, the inlay including a radio frequency identification antenna.

Optionally, the sheet does not conduct electric current.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A sheet assembly configured to be cut into one or more cards, the sheet assembly comprising:
an upper sheet configured to receive a first printing of first indicia for the one or more cards;
a polymer core coupled with the upper sheet; and
a lower sheet configured to receive a second printing of second indicia for the one or more cards, the lower sheet coupled with the polymer core with the polymer core disposed between the upper sheet and the lower sheet,
wherein one or more of the upper sheet, the polymer core, or the lower sheet is formed from a polymer binder with inorganic particles dispersed in the polymer binder, and
wherein one or more of:
the inorganic particles having a first density of the inorganic particles that is less than four times a second density of the polymer binder, or
a mass-median-diameter (D₅₀) of the inorganic particles is larger than ten microns in size.

2. The sheet assembly of claim 1, wherein the first density of the inorganic particles is at least 5.5 grams per cubic centimeter.

3. The sheet assembly of claim 1, wherein the second density of the polymer binder is at least 1.4 grams per cubic centimeter.

4. The sheet assembly of claim 1, wherein the inorganic particles include one or more of bismuth vanadate, one or more metal oxide pigments, or one or more conductive particles.

5. The sheet assembly of claim 4, wherein the inorganic particles include the one or more conductive particles, which include one or more of copper particles or bronze particles.

6. The sheet assembly of claim 1, wherein the polymer binder includes one or more of polyvinyl chloride, chlorinated polyvinyl chloride, polyvinylidene chloride, polyvinylidene fluoride, polytetrafluoroethylene, polyethylene terephthalate, polyethylene terephthalate glycol-modified, a bio-based polymer, a cellulosic polymer, a polyolefin, a polyactic acid-based polymer, an oceans plastic, an ocean-bound plastic, or a recycled plastic.

7. The sheet assembly of claim 1, wherein the upper sheet, the polymer core, and the lower sheet continuously extend from a first edge of the sheet to an opposite second edge of the sheet, and the upper sheet, the polymer core, and the lower sheet continuously extend from a third edge of the sheet to an opposite fourth edge of the sheet with each of the third edge and the fourth edge continuously extending from the first edge to the second edge,
wherein the sheet assembly does not conduct electric current from any of the first edge, the second edge, the third edge, or the fourth edge to any of the first edge, the second edge, the third edge, or the fourth edge.

8. A method comprising:
forming a polymer core;
coupling an upper sheet to the polymer core, the upper sheet configured to receive a first printing of first indicia for one or more cards; and
coupling a lower sheet to the polymer core to form a sheet of the upper sheet, the polymer core, and the lower sheet, the lower sheet coupled with the polymer core with the polymer core disposed between the upper sheet and the lower sheet, the lower sheet configured to receive a second printing of second indicia for the one or more cards,
wherein the upper sheet, the polymer core, and the lower sheet are configured to be cut into one or more cards,
wherein one or more of the upper sheet, the polymer core, or the lower sheet includes inorganic particles dispersed in a polymer binder, wherein one or more of (a) a first density of the inorganic particles is less than four times a second density of the polymer binder or (b) a mass-median-diameter (D₅₀) of the inorganic particles is larger than ten microns in size.

9. The method of claim 8, wherein the first density of the inorganic particles is at least 5.5 grams per cubic centimeter.

10. The method of claim 8, wherein the second density of the polymer binder is at least 1.4 grams per cubic centimeter.

11. The method of claim 8, wherein the inorganic particles include one or more of bismuth vanadate, one or more metal oxide pigments, or one or more conductive particles.

12. The method of claim 11, wherein the inorganic particles include the one or more conductive particles, which include one or more of copper particles or bronze particles.

13. The method of claim 8, wherein the polymer binder includes one or more of polyvinyl chloride, chlorinated polyvinyl chloride, polyvinylidene chloride, polyvinylidene fluoride, polytetrafluoroethylene, polyethylene terephthalate, polyethylene terephthalate glycol-modified, a bio-based polymer, a cellulosic polymer, a polyolefin, a polyactic acid-based polymer, an oceans plastic, an ocean-bound plastic, or a recycled plastic.

14. The method of claim 8, wherein the upper sheet, the polymer core, and the lower sheet continuously extend from a first edge of the sheet to an opposite second edge of the sheet, and the upper sheet, the polymer core, and the lower sheet continuously extend from a third edge of the sheet to an opposite fourth edge of the sheet with each of the third edge and the fourth edge continuously extending from the first edge to the second edge,
wherein the sheet does not conduct electric current from any of the first edge, the second edge, the third edge, or the fourth edge to any of the first edge, the second edge, the third edge, or the fourth edge.

15. A sheet assembly configured to be cut into one or more cards, the sheet assembly comprising:
an upper sheet configured to receive a first printing of first indicia for the one or more cards;
a polymer core coupled with the upper sheet; and
a lower sheet configured to receive a second printing of second indicia for the one or more cards, the lower sheet coupled with the polymer core with the polymer core disposed between the upper sheet and the lower sheet,
wherein one or more of the upper sheet, the polymer core, or the lower sheet is formed from a polymer binder with inorganic particles dispersed in the polymer binder with a first density of the inorganic particles being at least 5.5 grams per cubic centimeter but less than four times a second density of the polymer binder that is at least 1.4 grams per cubic centimeter.

16. The sheet assembly of claim 15, wherein the upper sheet, the polymer core, and the lower sheet continuously extend from a first edge of the sheet to an opposite second edge of the sheet, and the upper sheet, the polymer core, and the lower sheet continuously extend from a third edge of the sheet to an opposite fourth edge of the sheet with each of the third edge and the fourth edge continuously extending from the first edge to the second edge,
wherein the sheet assembly does not conduct electric current from any of the first edge, the second edge, the third edge, or the fourth edge to any of the first edge, the second edge, the third edge, or the fourth edge.

17. The sheet assembly of claim 15, wherein the polymer core includes a radio frequency identification antenna.

18. The sheet assembly of claim 15, wherein the polymer core is formed from at least a front split core layer and a back split core layer with the front split core layer located between the back split core layer and the upper sheet and the back split core layer located between the front split core layer and the lower sheet.

19. The sheet assembly of claim 15, wherein the polymer core is formed from a front split core layer, a back split core layer, and an inlay disposed between the front split core layer and the back split core layer, the inlay including a radio frequency identification antenna.

20. The sheet assembly of claim 15, wherein the sheet does not conduct electric current.
